(19) United States
(12) Patent Application Publication
(10) Pub. No.: US 2010/0165261 A1
(43) Pub. Date: Jul. 1, 2010

(54) Touch Panel Structure With Polarizer Containing Poly (ethylene terephthalate)

(76) Inventor: Chia-Ling Lin, Kaohsiung County (TW)

Correspondence Address: NORTH AMERICA INTELLECTUAL PROPERTY CORPORATION, P.O. BOX 506, MERRIFIELD, VA, 22116, US

(21) Appl. No.: 12/410,478

(22) Filed: Mar. 25, 2009

(30) Foreign Application Priority Data
Dec. 25, 2008 (TW) 097150579

(51) Int. Cl. G02F 1/1335

(52) U.S. Cl. 349/96; 428/1.31

(57) ABSTRACT

The present invention relates to a touch panel structure with polarizer containing poly(ethylene terephthalate), which has a first polarizer and a second polarizer. Both contain poly(ethylene terephthalate) to replace triacetyl cellulose, so as to increase the quality of the polarizer and the touch panel. Furthermore, the first polarizer has an indium tin oxide layer or has a plurality of spacer dots deposed on the indium tin oxide layer.

### BACKGROUND OF THE INVENTION

1. Field of the Invention

The present invention relates to a touch panel, more particularly, to a touch panel structure with polarizer containing poly(ethylene terephthalate), which is used for improving the polarizer material of the resistive touch panel.

2. Description of Related Art

The touch panel technology is original from 1970 year and it had been developed by the United States army. After the touch panel technology was transferred to the folk, the folk developed it to many kinds of uses. The touch panel is a simplest communication interface among person and equipment communication interfaces. The touch panel's operation is using a finger and a handwriting pen to contact with the touch panel, then calculating the contact point's position by an inner device and transferring it to an information equipment, so as to attain input purpose. The touch panel can absorb more persons of no computer knowledge to exchange data each other, so as to increase the information exchanged degree. Hence, the touch panel is not only used for a personal carrying information product but also an family electric equipment, a public information equipment, a communication equipment, auto-equipment in the office, a data collection equipment, or industry equipment, etc.

The touch panel's technologies are divided into a resistive type, a capacitance type, an ultrasonic type, an optic (infrared ray) type and an electromagnetic type, etc. The touch panel of the resistive type has many advantages like light weight, low price and easy producing. Hence, the touch panel of the resistive type has a highest market occupied ratio, which is above 60%. The touch panel of the resistive type is almost used for the consumed electric product, which is like an order system, a personal digital assistant (PDA), an electric dictionary, a cell phone, a register, a credit card processor or a medical monitor system, etc.

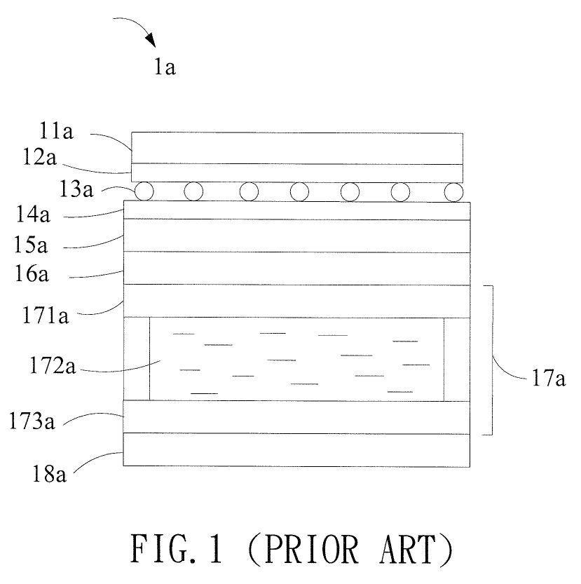

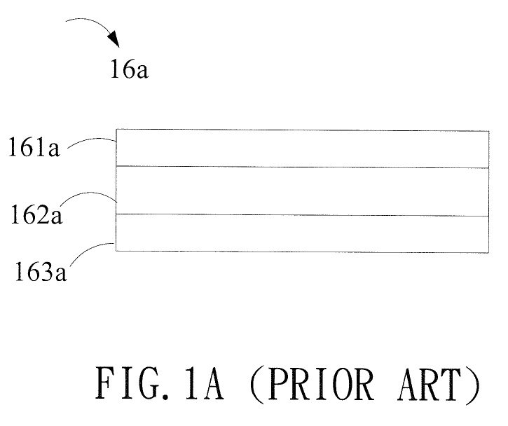

In the prior art, a structure for touch panel of resistive type is shown as FIG. 1. It includes a first poly(ethylene terephthalate) layer 11a; a first indium tin oxide layer 12a deposed beneath the first poly(ethylene terephthalate) layer 11a; a plurality of spacer dots 13a deposed beneath the first indium tin oxide layer 12a; a second indium tin oxide layer 14a deposed beneath the plurality of spacer dots 13a; a glass substrate 15a deposed beneath the second indium tin oxide layer 14a; a first polarizer 16a deposed beneath the glass substrate 15a; and a liquid crystal cell structure 17a deposed beneath the first polarizer 16a, wherein the liquid crystal cell structure 17a includes a first glass plate 171a; a liquid crystal layer 172a deposed beneath the first glass plate 171a; and a second glass plate 173a deposed beneath the liquid crystal layer 172a; and a second polarizer 18a deposed beneath the second glass plate 173a.

Because the plurality of spacer dots 13a is deposed between the first indium tin oxide layer 12a and the second indium tin oxide layer 14a, the first indium tin oxide layer 12a and the second indium tin oxide layer 14a are separated and isolated.

The first polarizer 16a is shown as FIG. 1A. It includes a first triacetyl cellulose layer 161a; a poly(vinyl alcohol) layer 162a deposed beneath the first triacetyl cellulose layer 161a and a second triacetyl cellulose layer 163a deposed beneath the poly(vinyl alcohol) layer 162a. Furthermore, the first polarizer 16a and the second polarizer 18a have the same layers' structure.

When a person uses the structure for touch panel of resistive type 1a, the first poly(ethylene terephthalate) layer 11a is pressed. Then, the first indium tin oxide layer 12a contacts with the second indium tin oxide layer 14a, so as to attain the purpose of electric connection. After the pressure force is removed, the first indium tin oxide layer 12a and the second indium tin oxide layer 14a are separated and isolated by the plurality of spacer dots 13a. Hence, the purpose of operating the structure for touch panel of resistive type 1a is attained.

Because the glass substrate 15a is deposed beneath the second indium tin oxide layer 14a in the structure for touch panel of resistive type 1a, the glass substrate 15a is easily broken and cuts the user during the operation time. Furthermore, the first polarizer 16a or the second polarizer 18a contain the triacetyl cellulose, which absorbs water easily, changes its shape easily, is not easy to pass light, has lower heat-resistant temperature, has lower hardness and is easy to be abraded. Hence, the structure for touch panel of resistive type 1a is damaged easily.

According to above disadvantages of the structure for touch panel of resistive type, the present invention provides a touch panel structure with polarizer containing poly(ethylene terephthalate), which uses poly(ethylene terephthalate) replace triacetyl cellulose for the polarizer's material. Hence, the present invention improves the disadvantages of the polarizer with triacetyl cellulose absorbing water easily, changing its shape easily, being not easy to pass light, having lower heat-resistant temperature, having lower hardness and being abraded easily, so as to increase the quality of the polarizer and the touch panel. Also, the present invention can reduce the glass substrate deposed beneath the second indium tin oxide layer so it can improve the disadvantage of the glass substrate broken easily and cutting the user during the operation time. Furthermore, the cost of the glass substrate can be economized.

### SUMMARY OF THE INVENTION

The main purpose of the present invention is to provide a touch panel structure with polarizer containing poly(ethylene terephthalate), which uses poly(ethylene terephthalate) replace triacetyl cellulose for the polarizer's material. Hence, it improves the disadvantages of the polarizer with triacetyl cellulose absorbing water easily, changing its shape easily, being not easy to pass light, having lower heat-resistant temperature, having lower hardness and being abraded easily, so as to increase the quality of the polarizer and the touch panel.

The other purpose of the present invention is to provide a touch panel structure with polarizer containing poly(ethylene terephthalate), which reduces the glass substrate deposed beneath the second indium tin oxide layer so it can improve the disadvantage of glass substrate broken easily and cutting the user during the operation time. Furthermore, the cost of the glass substrate can be economized.

In order to attain above purposes, the present invention provides a touch panel structure with polarizer containing poly(ethylene terephthalate), which comprises a first polarizer containing poly(ethylene terephthalate) and having a first indium tin oxide layer deposed at the bottom thereof; a plurality of spacer dots deposed beneath the first indium tin oxide layer of the first polarizer; a second indium tin oxide layer deposed beneath the plurality of spacer dots; a liquid crystal cell structure deposed beneath the second indium tin oxide layer; and a second polarizer deposed beneath the liquid crystal cell structure.

In order to attain above purposes, the present invention provides the other touch panel structure with polarizer containing poly(ethylene terephthalate), which comprises a first poly(ethylene terephthalate) layer; a first indium tin oxide layer deposed beneath the first poly(ethylene terephthalate) layer; a plurality of spacer dots deposed beneath the first indium tin oxide layer; a first polarizer deposed beneath the plurality of spacer dots, the first polarizer containing poly(ethylene terephthalate) and having a second indium tin oxide layer deposed at the top thereof; a liquid crystal cell structure deposed beneath the first polarizer; and a second polarizer deposed beneath the liquid crystal cell structure.

### BRIEF DESCRIPTION OF THE DRAWINGS

The structure and the technical means adopted by the present invention to achieve the above and other purposes can be best understood by referring to the following detailed description of the preferred embodiments and the accompanying drawings, wherein

The FIG. 1 is a schema of the structure for touch panel of resistive type in the prior art;

The FIG. 1A is a schema of the first polarizer of a structure for touch panel of resistive type in the prior art;

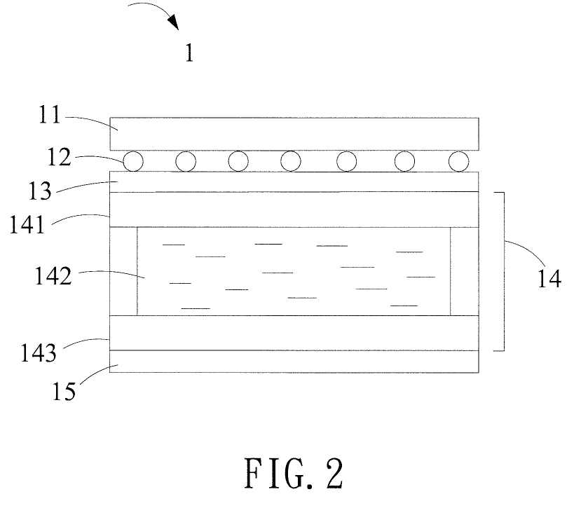

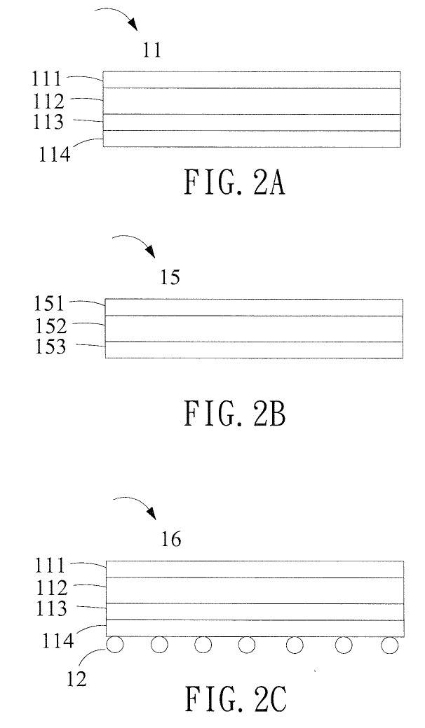

The FIG. 2 is a schema of a touch panel structure with polarizer containing poly(ethylene terephthalate) of a first embodiment of the present invention;

The FIG. 2A is a schema of a first polarizer of the first embodiment of the present invention;

The FIG. 2B is a schema of a second polarizer of the first embodiment of the present invention;

The FIG. 2C is a schema of a third polarizer of the first embodiment of the present invention;

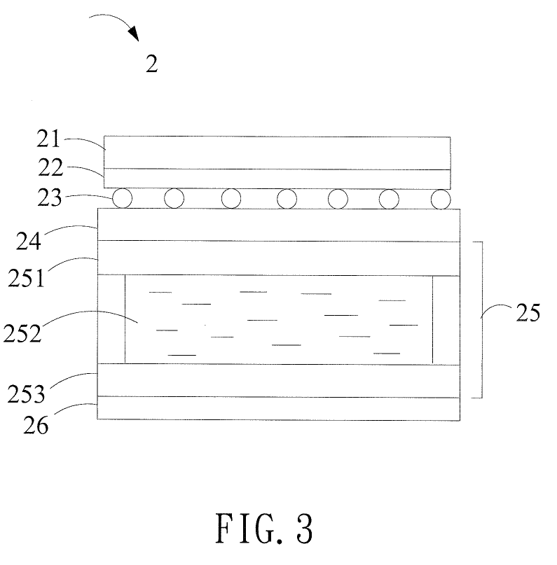

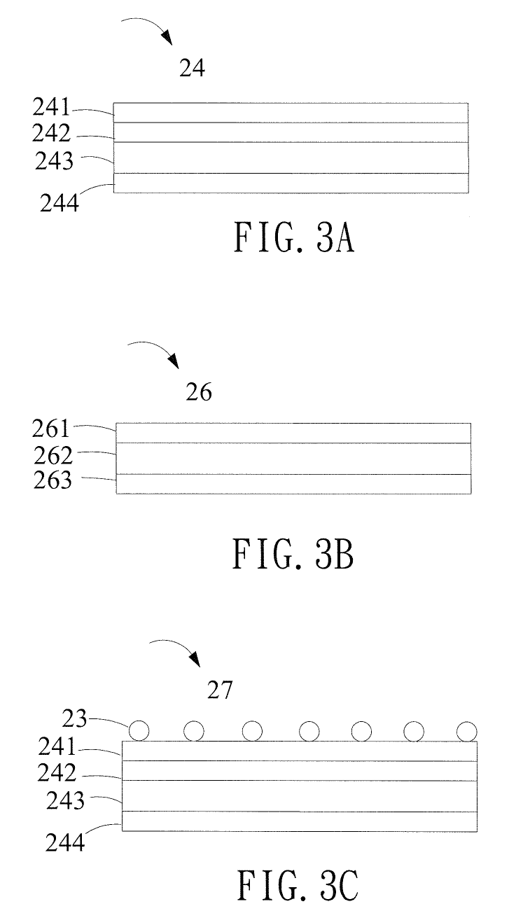

The FIG. 3 is a schema of a touch panel structure with polarizer containing poly(ethylene terephthalate) of a second embodiment of the present invention;

The FIG. 3A is a schema of a first polarizer of the second embodiment of the present invention;

The FIG. 3B is a schema of a second polarizer of the second embodiment of the present invention; and

The FIG. 3C is a schema of a third polarizer of the second embodiment of the present invention.

### DESCRIPTION OF THE EMBODIMENTS

### The First Embodiment

The touch panel structure with polarizer containing poly(ethylene terephthalate) of the first embodiment of the present invention is shown as FIG. 2 and FIG. 2A. It includes a first polarizer 11 containing poly(ethylene terephthalate) and having a first indium tin oxide layer 114 deposed at the bottom thereof; a plurality of spacer dots 12 deposed beneath the first indium tin oxide layer 114 of the first polarizer 11; a second indium tin oxide layer 13 deposed beneath the plurality of spacer dots 12; a liquid crystal cell structure 14 deposed beneath the second indium tin oxide layer 13; and a second polarizer 15 deposed beneath the liquid crystal cell structure 14.

The first polarizer 11 includes a first poly(ethylene terephthalate) layer 111; a first poly(vinyl alcohol) layer 112 deposed beneath the first poly(ethylene terephthalate) layer 111; a second poly(ethylene terephthalate) layer 113 deposed beneath the first poly(vinyl alcohol) layer 112; and the first indium tin oxide layer 114 deposed beneath the second poly(ethylene terephthalate) layer 113. Furthermore, the first indium tin oxide layer 114 can directly be spread and sputtered on the surface of the second poly(ethylene terephthalate) layer 113 to form a portion of the first polarizer 11. Also, a first liquid crystal material can be added in the second poly(ethylene terephthalate) layer 113 to increase the visual angle of the touch panel structure with polarizer containing poly(ethylene terephthalate) 1.

The liquid crystal cell structure 14 includes a first glass plate 141; a liquid crystal layer 142 deposed beneath the first glass plate 141; and a second glass plate 143 deposed beneath the liquid crystal layer 142.

Please see the FIG. 2B. The second polarizer 15 includes a third poly(ethylene terephthalate) layer 151; a second poly(vinyl alcohol) layer 152 deposed beneath the third poly(ethylene terephthalate) layer 151; a fourth poly(ethylene terephthalate) layer 153 deposed beneath the second poly(vinyl alcohol) layer 152. Furthermore, a second liquid crystal material is added in the third poly(ethylene terephthalate) layer 151 to increase the visual angle of the touch panel structure with polarizer containing poly(ethylene terephthalate) 1.

Please further refer to the FIG. 2C. The plurality of spacer dots 12 can be sprayed on the surface of the first indium tin oxide layer 114 of the first polarizer 11 to form a third polarizer 16. Hence, the plurality of spacer dots 12 becomes a portion of the third polarizer 16.

### The Second Embodiment

The touch panel structure with polarizer containing poly(ethylene terephthalate) of the second embodiment of the present invention is shown as FIG. 3 and FIG. 3A. It includes a first poly(ethylene terephthalate) layer 21; a first indium tin oxide layer 22 deposed beneath the first poly(ethylene terephthalate) layer 21; a plurality of spacer dots 23 deposed beneath the first indium tin oxide layer 22; a first polarizer 24 deposed beneath the plurality of spacer dots 23, the first polarizer 24 containing poly(ethylene terephthalate) and having a second indium tin oxide layer 241 deposed at the top thereof; a liquid crystal cell structure 25 deposed beneath the first polarizer 24; and a second polarizer 26 deposed beneath the liquid crystal cell structure 25.

The first polarizer 24 includes the second indium tin oxide layer 241; a second poly(ethylene terephthalate) layer 242 deposed beneath the second indium tin oxide layer 241; a first poly(vinyl alcohol) layer 243 deposed beneath the second poly(ethylene terephthalate) layer 242; and a third poly(ethylene terephthalate) layer 244 beneath the first poly(vinyl alcohol) layer 243. Furthermore, the second indium tin oxide layer 241 can be spread or sputtered on the surface of the second poly(ethylene terephthalate) layer 242 to form a portion of the first polarizer 24. Also, a first liquid crystal material can be added in the third poly(ethylene terephthalate) layer 244 to increase the visual angle of the touch panel structure with polarizer containing poly(ethylene terephthalate) 2.

The liquid crystal cell structure 25 includes a first glass plate 251; a liquid crystal layer 252 deposed beneath the first glass plate 251; and a second glass plate 253 deposed beneath the liquid crystal layer 252.

Please see the FIG. 3B. The second polarizer 26 includes a fourth poly(ethylene terephthalate) layer 261; a second poly(vinyl alcohol) layer 262 deposed beneath the fourth poly(ethylene terephthalate) layer 261; and a fifth poly(ethylene terephthalate) layer 263 deposed beneath the second poly(vinyl alcohol) layer 262. Furthermore, a second liquid crystal material is added in the fourth poly(ethylene terephthalate) layer 261 to increase the visual angle of the touch panel structure with polarizer containing poly(ethylene terephthalate) 2.

Further refer to the FIG. 3C. The plurality of spacer dots 23 can be sprayed on the surface of the second indium tin oxide layer 241 of the first polarizer 24 to form a third polarizer 27. Hence, the plurality of spacer dots 23 becomes a portion of the third polarizer 27.

According to above mention, the touch panel structure with polarizer containing poly(ethylene terephthalate) of the present invention has advantages as following:
1. The touch panel structure with polarizer containing poly(ethylene terephthalate) of the present invention uses poly(ethylene terephthalate) to replace triacetyl cellulose for the polarizer's material. Hence, it improves the disadvantages of the polarizer with triacetyl cellulose absorbing water easily, changing its shape easily, being not easy to pass light, having lower heat-resistant temperature, having lower hardness and being abraded easily, so as to increase the quality of the polarizer and the touch panel.
2. The touch panel structure with polarizer containing poly(ethylene terephthalate) of the present invention reduces the glass substrate deposed beneath the second indium tin oxide layer so it can improve the disadvantage of glass substrate broken easily and cutting the user during the operation time. Furthermore, the cost of the glass substrate can be economized.

It will be apparent to those skilled in the art that various modifications and variations can be made to the material and structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel structure with polarizer containing poly(ethylene terephthalate) comprising:
a first polarizer containing poly(ethylene terephthalate) and having a first indium tin oxide layer deposed at the bottom thereof;
a plurality of spacer dots deposed beneath the first indium tin oxide layer of the first polarizer;
a second indium tin oxide layer deposed beneath the plurality of spacer dots;
a liquid crystal cell structure deposed beneath the second indium tin oxide layer; and
a second polarizer deposed beneath the liquid crystal cell structure.

2. The touch panel structure with polarizer containing poly(ethylene terephthalate) according to claim 1, wherein the first polarizer comprises a first poly(ethylene terephthalate) layer; a first poly(vinyl alcohol) layer deposed beneath the first poly(ethylene terephthalate) layer; a second poly(ethylene terephthalate) layer deposed beneath the first poly(vinyl alcohol) layer; and the first indium tin oxide layer deposed beneath the second poly(ethylene terephthalate) layer.

3. The touch panel structure with polarizer containing poly(ethylene terephthalate) according to claim 2, wherein the first polarizer and the plurality of spacer dots form a third polarizer.

4. The touch panel structure with polarizer containing poly(ethylene terephthalate) according to claim 2, further comprising a first liquid crystal material added in the second poly(ethylene terephthalate) layer.

5. The touch panel structure with polarizer containing poly(ethylene terephthalate) according to claim 1, wherein the liquid crystal cell structure comprises a first glass plate; a liquid crystal layer deposed beneath the first glass plate; and a second glass plate deposed beneath the liquid crystal layer.

6. The touch panel structure with polarizer containing poly(ethylene terephthalate) according to claim 1, wherein the second polarizer comprises a third poly(ethylene terephthalate) layer; a second poly(vinyl alcohol) layer deposed beneath the third poly(ethylene terephthalate) layer; and a fourth poly(ethylene terephthalate) layer deposed beneath the second poly(vinyl alcohol) layer.

7. The touch panel structure with polarizer containing poly(ethylene terephthalate) according to claim 6, further comprising a second liquid crystal material added in the third poly(ethylene terephthalate) layer.

8. A touch panel structure with polarizer containing poly(ethylene terephthalate) comprising:
a first poly(ethylene terephthalate) layer;
a first indium tin oxide layer deposed beneath the first poly(ethylene terephthalate) layer;
a plurality of spacer dots deposed beneath the first indium tin oxide layer;
a first polarizer deposed beneath the plurality of spacer dots, the first polarizer containing poly(ethylene terephthalate) and having a second indium tin oxide layer deposed at the top thereof;
a liquid crystal cell structure deposed beneath the first polarizer; and
a second polarizer deposed beneath the liquid crystal cell structure.

9. The touch panel structure with polarizer containing poly(ethylene terephthalate) according to claim 8, wherein the first polarizer comprises the second indium tin oxide layer; a second poly(ethylene terephthalate) layer deposed beneath the second indium tin oxide layer; a first poly(vinyl alcohol) layer deposed beneath the second poly(ethylene terephthalate) layer; and a third poly(ethylene terephthalate) layer beneath the first poly(vinyl alcohol) layer.

10. The touch panel structure with polarizer containing poly(ethylene terephthalate) according to claim 9, wherein the plurality of spacer dots and the first polarizer form a third polarizer.

11. The touch panel structure with polarizer containing poly(ethylene terephthalate) according to claim 9, further comprising a first liquid crystal material added in the third poly(ethylene terephthalate) layer.

12. The touch panel structure with polarizer containing poly(ethylene terephthalate) according to claim 8, wherein the liquid crystal cell structure comprises a first glass plate; a liquid crystal layer deposed beneath the first glass plate; and a second glass plate deposed beneath the liquid crystal layer.

13. The touch panel structure with polarizer containing poly(ethylene terephthalate) according to claim 8, wherein the second polarizer comprises a fourth poly(ethylene terephthalate) layer; a second poly(vinyl alcohol) layer deposed beneath the fourth poly(ethylene terephthalate) layer; and a fifth poly(ethylene terephthalate) layer deposed beneath the second poly(vinyl alcohol) layer.

14. The touch panel structure with polarizer containing poly(ethylene terephthalate) according to claim 13, further comprising a second liquid crystal material added in the forth poly(ethylene terephthalate) layer.
